(19) United States
(12) Patent Application Publication
(10) Pub. No.: US 2011/0221343 A1
(43) Pub. Date: Sep. 15, 2011

(54) Decorative Lamp String with Open-Circuit-Proof and Over-Current-Proof Structure

(76) Inventor: Chengju Kuo, Guangdong (CN)

(21) Appl. No.: 12/991,467

(22) PCT Filed: Dec. 8, 2009
(86) PCT No.: PCT/CN09/75379

§ 371 Date: Nov. 8, 2010

(51) Int. Cl. H01J 7/44

(52) U.S. Cl. 315/41

(57) ABSTRACT

A decorative light string with open-circuit-proof and over-current-proof structure includes a plurality of lamp units arranged electrically in series with each other by a power lead. Each lamp unit includes a soft bulb socket, a soft bulb receptacle mounted in the soft bulb socket and a bulb mounted in the soft bulb receptacle. Two conductive wires of the bulb are in contact with two elastic contact plates mounted in said soft bulb socket. The soft bulb socket has a tail plug with a resistor which has approximately equal resistance value to the resistance of said bulb. Two conductive wires of the resistor extend through the tail plug and are attached to lateral sides thereof corresponding to the positions of the two elastic contact plates. The maximum distance between the two conductive wires of the bulb on the bulb receptacle exceeds the maximum distance between two wires of the resistor on the tail plug. Thus, when the bulb is removed, the two elastic contact plates spring inwards and contact the conductive wires of the resistor to maintain the current in a stable condition.

### FIELD OF THE INVENTION

The present invention is related to a decorative lamp string, in particular a decorative lamp string with open-circuit-proof and over-current-proof structure.

### BACKGROUND OF THE INVENTION

Festival lamp strings, such as Christmas tree lights, are widely used to enhance a festival atmosphere because of their various forms and colors. However, at present the conventional festival lamp strings available commercially typically have a structure where all bulbs are connected in series by a power lead. Thus, the loss of one of these bulbs will cause the whole lamp string to stop working. This result has a negative impact on the decorative effect of the lamp strings.

Some later designs have addressed the problem of these conventional festival lamp strings and ensure that other bulbs work normally even when one of the bulbs comes out by using spring piece as contact plate in the lamp receptacle to maintain the circuit when a bulb is lost. However, when more bulbs are lost, the power cord may be burned out because of being overloaded.

In order to address the safety problem of power cord overload, one solution has been to attach a safety bulb in the lamp string for overcurrent protection. When the current in the lamp string exceeds specific amperage, the safety bulb blows to interrupt the circuit to protect the lamp string. Though this scheme has higher safety level, the loss of the safety bulb leads to abnormal working condition. Furthermore, the safety bulb requires particular attention in assembly, resulting in lower working efficiency and reduced manufacturing productivity.

### SUMMARY OF THE INVENTION

In order to overcome the deficiencies of the existing technologies, the present invention provides a decorative lamp string with an open-circuit-proof and over-current-proof structure, which is safe and reliable, and has a long-lifetime and is easy to assemble or manufacture.

A decorative light string in accordance with the present invention, includes a soft bulb socket, a soft bulb receptacle mounted in the soft bulb socket and a bulb mounted in said soft bulb receptacle. The two conductive wires of the bulb are in contact with two elastic contact plates mounted in the soft bulb socket. The soft bulb socket also includes a tail plug, and a resistor mounted in the tail plug which has an equal resistance value to the resistance of the bulb. The two conductive wires of the resistor extend through the tail plug and are attached to the two lateral sides thereof corresponding to the positions of the two elastic contact plates respectively. The maximum distance between the two conductive wires of the bulb on the bulb receptacle exceeds the maximum distance between two wires of the resistor on the tail plug. When the bulb with the soft bulb receptacle is removed from the soft bulb socket, the two elastic contact plates spring inwards and come into contact with the conductive wires of the resistor.

The invention has the advantage that each lamp unit includes a resistor having a resistance value that is equal to the resistance value of the bulb. When the lamp string is functioning properly, the resistor is not involved with the functioning of the lamp string. However, when the bulb with its bulb receptacle is removed, the two elastic contact plates spring inward immediately and contact the conductive wires of the resistor, replacing the lost bulb with the resistor so that the lamp string is restored to its normal working condition. Even when more bulbs are lost, the overall operating current of the lamp string can still remain stable since an equal number of resistors are involved. Thus, no safety risk is incurred. In addition to the above, since the structures of the soft bulb receptacles in the lamp string are all the same of shape, the assembling process is simplified and a higher production efficiency is achieved.

### BRIEF DESCRIPTION OF THE DRAWINGS

FIG. 1 is a schematic view of the present invention;

FIG. 2 is a structural decomposition view of the present invention;

FIG. 3 is a structural decomposition view of the tail plug and soft bulb socket.

### DETAILED DESCRIPTION

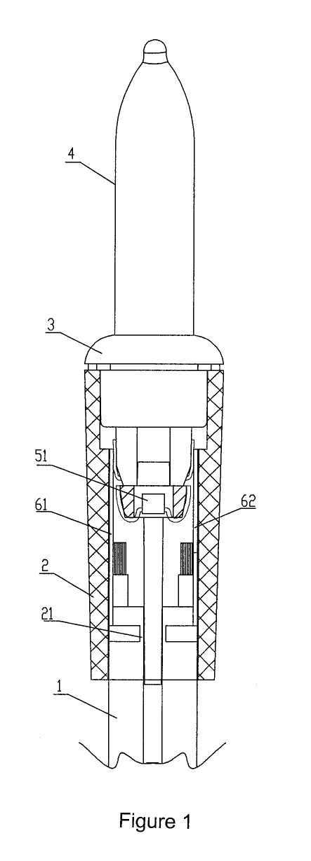

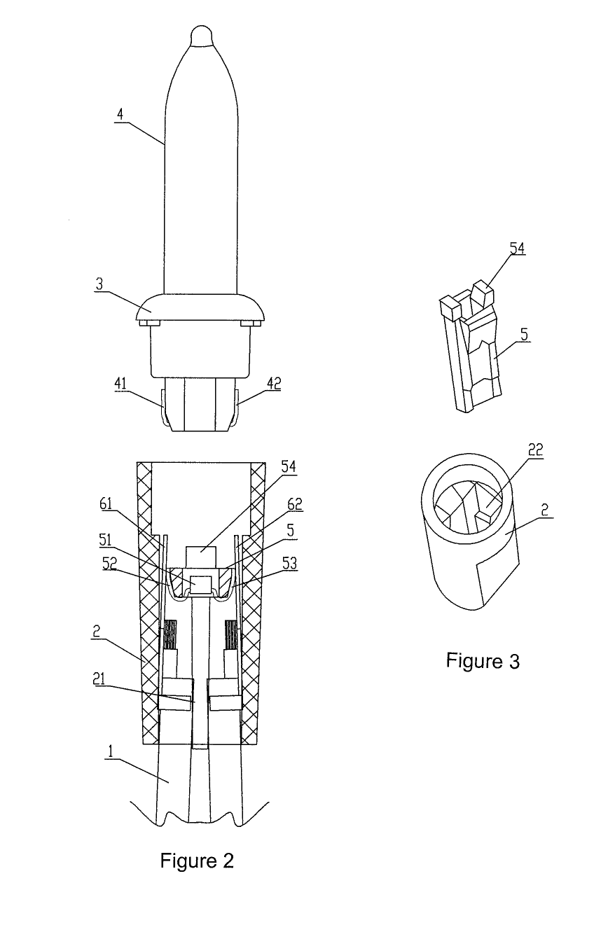

As shown in FIGS. 1 to 3, the decorative light string with an open-circuit-proof and over-current-proof structure comprises a plurality of lamp units connected in series by a power lead 1. Each lamp unit comprises a soft bulb socket 2 which includes a soft bulb receptacle 3 and a tail plug 5, wherein the soft bulb receptacle 3 is for mounting a bulb 4. The tail plug 5 is mounted under the bulb receptacle 3 in the bulb socket 2, and includes a resistor 51 that has a resistance value which is approximately equal to the resistance value of the bulb 4. Furthermore, the left and right conductive wires 41, 42 of said bulb 4 are respectively in contact with the left and right elastic contact plates 61, 62 mounted in the soft bulb socket 2, while the two conductive leads 52, 53 of the resistor 51 extend through the tail plug 5 and are attached to the two lateral sides thereof corresponding to the positions of the two elastic contact plates 61, 62 respectively. The maximum distance between the two conductive wires 41, 42 of the bulb 4 on the bulb receptacle 3 exceeds the maximum distance between two wires 52, 53 of the resistor 51 on said tail plug 5.

For assembly, the bulb 4 is inserted in the bulb receptacle 3 and then the bulb assembly is inserted in the bulb socket 2. As shown in FIG. 1, the head of the bulb receptacle 3 props open the left and right elastic contact plates 61, 62 to form gaps between the left, right elastic contact plates 61, 62 and the tail plug 5. When energized, the current flows through the left elastic contact plate 61, left lead of the bulb 41, the bulb 4, the right lead of the bulb 42, and the right elastic contact plate 62 in order, to form a current circuit.

As shown in FIG. 3, when the bulb 4 with the bulb receptacle 3 is removed from the bulb socket 2, the left, right elastic contact plates 61, 62 spring inwards and contact with the left, right conductive wires 52, 53 of the resistor 51. Thus the resistor 51 replaces the removed bulb 4 in the circuit and therefore other bulbs 4 in the circuit can still remain in lighting-up normally. Even if more bulbs 4 are removed, the overall operating current of the lamp string can still remain stable, and as a result, no safety risk is incurred.

In accordance with the present invention, the left and right elastic contact plates 61, 62 are in a sector shape, having a broad apex and a narrow base, similarly, the contact areas between the tail plug 5 and the soft bulb socket 2 are also sector-shaped.

In order to ensure the tail plug 5 interposed locates exactly in the center of the soft bulb socket 2, as well as to provide more stability for the cooperation between the tail plug 5 and the bulb socket 2, a guide groove 22 is formed in the bulb socket 2 for receiving the tail plug 5. This structure eliminates a shaking phenomena of the tail plug 5, and consequently improves the reliability of the product significantly.

Furthermore, in order to prevent the tail plug 5 from being interposed too deeply in the soft bulb socket 2, matched positioning blocks 54 on the bottom of the tail plug and recesses 22 in the soft bulb socket 2 are provided.

For convenience in inserting the soft bulb receptacle 3, the soft bulb receptacle 3 has a chamfer on its bottom, and the left and right wires 41, 42 of the bulb 4 conform closely to the chamfer.

In order to guarantee that the operating current can remain stable after some of the bulbs 4 are removed, the resistance value of the selected resistor 51 is expected to be as close as possible to the resistance value of the bulb 4. Preferably, the resistance value of the selected resistor 51 is within the scope of 0.8˜1.4 times of the resistance value of the bulb 4.

The embodiment described herein not only can be applied in conventional decorative lamp strings, but also can be applied in decorative LED lamp strings.

The above description illustrates a preferred embodiment of the present invention, and should not be interpreted as giving any limitation to the scope of the present invention. It will be apparent to those skilled in this art that all equivalent modifications and changes shall fall within the scope of the appended claims and are intended to form part of this invention.

1. A decorative light string with open-circuit-proof and over-current-proof structure, comprising a plurality of lamp units arranged electrically in series with each other by a power lead, each lamp unit having a soft bulb socket, a soft bulb receptacle mounted in said soft bulb socket and a bulb mounted in said soft bulb receptacle, wherein the two conductive wires of said bulb are in contact with the two elastic contact plates mounted in said soft bulb socket, and said soft bulb socket further comprises a tail plug, and a resistor mounted in said tail plug with equal resistance value to the resistance of said bulb, wherein the two conductive wires of said resistor extend through said tail plug and are attached to the two lateral sides thereof corresponding to the positions of the two elastic contact plates respectively, and the maximum distance between the two conductive wires of said bulb on said bulb receptacle exceeds the maximum distance between two wires of said resistor on said tail plug, thus when said bulb with said soft bulb receptacle is removed from said soft bulb socket, the two elastic contact plates spring inwards and come into contact with the conductive wires of said resistor respectively.

2. A decorative lamp string with an open-circuit proof and over-current-proof structure as claimed in claim 1, wherein said soft bulb socket has a guide groove formed for mounting said tail plug.

3. A decorative lamp string with an open-circuit proof and over-current-proof structure as claimed in claim 1, wherein said tail plug has positioning blocks on its top, corresponding to the matched recesses in said soft bulb socket.

4. A decorative lamp string with an open-circuit proof and over-current-proof structure as claimed in claim 1, wherein said two elastic contact plates are wide at the top and narrow at the bottom, having a sector shape.

5. A decorative lamp string with an open-circuit proof and over-current-proof structure as claimed in claim 1, wherein the resistance value of said resistor is within 0.8˜1.4 times of the resistance value of said bulb.

6. A lamp unit for use in a decorative light string in which a plurality of lamp units are arranged electrically in series with each other by a power lead which provides for an open-circuit-proof and over-current-proof structure, comprising:
a soft bulb socket;
a soft bulb receptacle mounted in or mountable in said soft bulb socket;
a bulb mounted in or mountable in said soft bulb receptacle, said bulb having a first resistance;
a tail plug positioned within said soft bulb socket;
a resistor positioned in said tail plug, said resistor having a second resistance, wherein said first resistance of said bulb and said second resistance of said resistor are approximately equal;
a first pair of spaced apart wires on said bulb for passing current through said bulb, said first pair of spaced apart wires being spaced apart by a first distance;
a second pair of spaced apart wires connected to said resistor for passing current through said resistor, said second pair of spaced apart wires being spaced apart by a second distance wherein said second distance is smaller than said first distance; and
two elastic contact plates mounted in said soft bulb socket which are electrically connected to said power lead and which can move at least between a distance apart equal to said first distance or said second distance,
said two elastic plates being connectable to said first pair of spaced apart wires if said bulb and said soft bulb receptacle are mounted in said soft bulb socket,
said two elastic plates being connectable to said second pair of spaced apart wires if said bulb and said soft bulb receptacle are removed from said soft bulb socket,
